(19) United States
(12) Patent Application Publication
(10) Pub. No.: US 2021/0319679 A1
(43) Pub. Date: Oct. 14, 2021

(54) POACHING DETECTION APPARATUS

(71) Applicant: Mark E. McDonald, Gainsville, VA (US)

(72) Inventor: Mark E. McDonald, Gainsville, VA (US)

(21) Appl. No.: 17/226,699

(22) Filed: Apr. 9, 2021

Related U.S. Application Data
(60) Provisional application No. 63/007,422, filed on Apr. 9, 2020.

(51) Int. Cl. G08B 13/189; G08B 25/10

(52) U.S. Cl. CPC G08B 13/1895; G08B 25/10

(57) ABSTRACT

A poaching detection apparatus includes a frame member with first and second reflectors mounted thereto. The reflectors mimic the reflective qualities of the eyes of certain animals; accordingly, the reflectors will appear to be animal eyes when a poacher shines a portably light on them. The poaching detection apparatus also includes at least one light sensor that, when struck by the light from a poacher using a “spotlighting” technique, causes the activation of at least one alarm and/or alert to deter the poacher and/or notify property owners or authorities of the presence of poachers

### CROSS REFERENCE TO RELATED APPLICATION

This application claims the benefit of U.S. Provisional Patent Application No. 63/007,422, filed Apr. 9, 2020, and which is hereby incorporated by reference in its entirety.

### TECHNICAL FIELD

This disclosure relates to anti-poaching systems.

### BACKGROUND

Poaching is the illegal or unauthorized hunting of animals. One method frequently employed by poachers is often referred to as “spotlighting.” Spotlighting includes searching for animals at night with a portable light; the reflective qualities of the eyes of certain animals (such as deer) will make the animals easily noticeable to poachers as the light from the portable light is reflected back to the poachers. Furthermore, the light causes some animals to remain in place, which enables the poachers to approach the animal.

### SUMMARY

A poaching detection apparatus includes a frame member with first and second reflectors mounted thereto. The reflectors mimic the reflective qualities of the eyes of certain animals; accordingly, the reflectors will appear to be animal eyes when a poacher shines a portably light on them. The poaching detection apparatus also includes at least one light sensor that, when struck by the light from a poacher, causes the activation of at least one alarm and/or alert to deter the poacher and/or notify property owners or authorities of the presence of poachers.

The poaching detection apparatus deters poaching in at least three ways. First, the reflectors deceive poachers by mimicking the appearance of eyes of the poacher's target. Second, the alarm informs poachers that they have been detected and are at risk of being apprehended and prosecuted. Third, the alert notifies property owners and/or authorities of the poaching activity so that appropriate action can be taken.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, front view of a poaching detection apparatus in accordance with the claimed invention; and

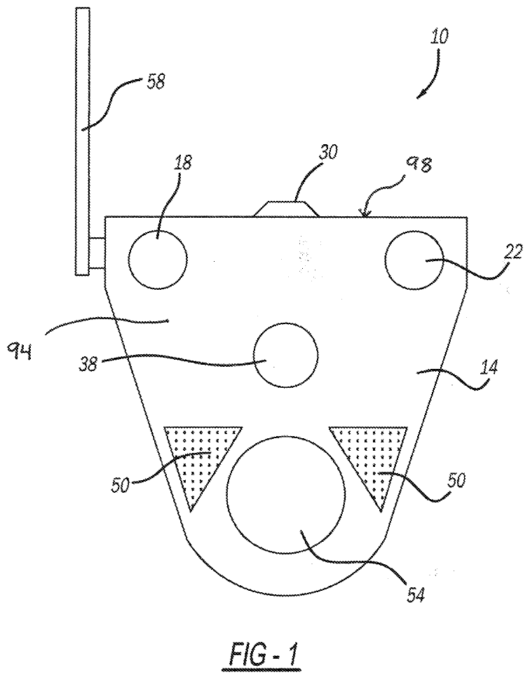

FIG. 2 is a schematic diagram of the electronic components of the apparatus of FIG. 1.

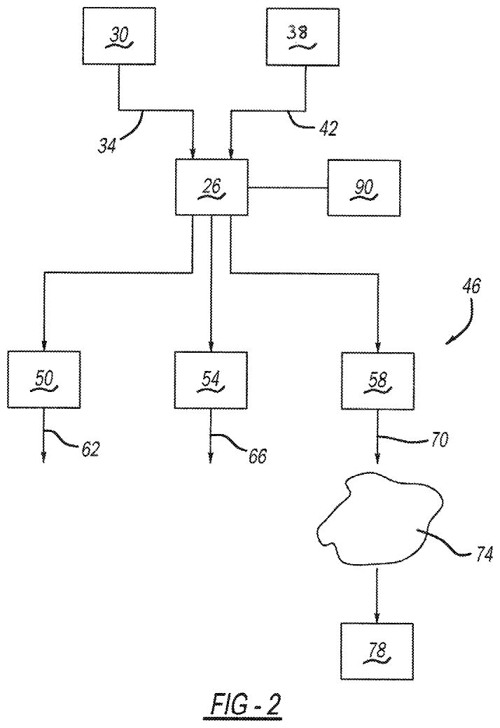

### DESCRIPTION OF THE PREFERRED EMBODIMENTS

Referring to the Figures, a poaching detection apparatus 10 includes a frame 14. The frame 14 provides structure to the apparatus 10 and interconnects the other components of the apparatus 10. The frame 14 may have any shape or configuration and be formed of any suitable material within the scope of the claimed invention. The apparatus 10 also includes a first reflector 18 and a second reflector 22 mounted to the frame 14. The first and second light reflectors 18, 22 are configured to reflect light. In one preferred embodiment, the reflectors 18, 22 are retroreflectors that are configured to reflect light in the direction of the light source with minimal scattering and for a relatively wide range of angle of incidence.

The apparatus 10 also includes a control system 26 mounted with respect to the frame 14. The control system 26 in the embodiment depicted includes a microprocessor configured and programmed to perform the functions described herein. However, it should be noted that any apparatus, including, but not limited to, analog circuitry, that is configured to perform the functions described herein may be employed within the scope of the claimed invention.

The apparatus 10 also includes a first photosensor 30 operatively connected to the control system 26 and configured to transmit a first signal 34 to the control system 26 that is indicative of the amount of light reaching the first photosensor 30. The apparatus 10 includes second photosensor 38 operatively connected to the control system 26 and configured to transmit a second signal 42 to the control system 26 that is indicative of the amount of light reaching the second photosensor 38.

An alarm system 46 is operatively connected to the control system 26 and is configured to selectively produce at least one alert signal. In the embodiment depicted, the alarm system 46 includes speakers 50, a light-emitting device 54, and a wireless signal transmitter 58. The speakers 50 are configured to selectively produce an audible sound 62. The light-emitting device 54 is configured to selectively produce light 66 in the visible spectrum. The wireless signal transmitter 58 is configured to transmit a wireless signal 70 to a wireless communications network 74.

The control system 26 is programmed and configured to cause the alarm system 46 to produce the alert signal when the first signal 34 indicates that the amount of light reaching the first photosensor 30 is less than a predetermined amount and the second signal 42 indicates that the amount of light reaching the second photosensor 38 is above a predetermined amount. The first photosensor 30 thus functions to limit the activation of the alert signal to night. The second photosensor 38 functions to determine whether a poacher is shining a light at the apparatus 10. The alert signal will be produced only when both conditions are met (i.e., both night and a light is shone at the apparatus 10). Accordingly, during the daytime both photosensors 30, 34 would be receiving light above the predetermined amount, and the control system will not cause an alert signal.

The alert signal is one or more of the sound 62, the light 66, and the wireless signal 70. Thus, when the first photosensor 30 indicates that it is night (i.e., the amount of light reaching the first photosensor 30 is less than a predetermined amount) and the second photosensor 38 indicates that a poacher's light is shining on it (i.e., the amount of light reaching the second photosensor is greater than another predetermined amount), then the control system 26 causes the speakers 50 to produce the sound 62, the light-producing device 54 to emit the light 66, and/or the wireless transmitter 58 to transmit the wireless signal 70.

Those skilled in the art will recognize a variety of light-producing devices that may be employed within the scope of the claimed invention including, but not limited to, strobe lights, incandescent lights, light-emitting diodes, etc. The wireless communication network 74 is configured to respond to the wireless signal 70 by causing an electronic device 78, such as a mobile phone or computer tablet, to generate an alert, which may, for example, be a sound or notification on a screen. Example alerts may include text messages, apps, emails, etc. The wireless network 74 may, for example, be a cellular telephone network, satellite system, internet or other computer network, or any combination of the foregoing.

The apparatus 10 may also include a counter to record the number of times it has been activated, and a strap mounted to the frame 14 for connecting the apparatus 10 to a vertical support such as a tree, fence post, etc. As understood by those skilled in the art, the components 30, 38, 50, 54, 58 are operatively connected to a battery 90. In the embodiment depicted, the frame 14 is in the form of a housing, with the battery 90 and the control system 26 contained therein.

The housing defines a generally planar surface 94. The first and second reflectors 18, 22 are mounted to surface 94. Photosensor 38 is also mounted to surface 94, or is exposed through a hole in the surface 94. The light source 54 and speakers 50 are also either mounted to surface 94 or exposed through holes in the surface 94. Photosensor 30 is mounted to, or exposed through, a surface different from surface 94, such as a surface 98 that is perpendicular to the surface 94.

A method of using the apparatus 10 includes placing the apparatus 10 outdoors, such as by fastening the apparatus to a tree, fencepost, etc., and leaving the apparatus 10 outdoors at night. The apparatus 10 is positioned such that surface 94 is vertically oriented so that the second photosensor 38 and the reflectors 18, 22 are positioned to receive light from a poacher, and the surface 98 is horizontally-oriented so that the first photosensor 34 would not receive direct light from a poacher. Surface 94 may be positioned to face a road, path, etc. from which a poacher may be shining a spotlight while searching for deer or other animals.

It should be noted that in one embodiment, only apparatus 10 includes only the reflectors 18, 22 mounted to a frame such as a plastic stick having a length of approximately five inches. The reflectors 18, 22 are white in color.

While the best modes for carrying out the invention have been described in detail, those familiar with the art to which this invention relates will recognize various alternative designs and embodiments for practicing the invention within the scope of the appended claims.

1. A poaching detection apparatus comprising:
a frame;
first and second reflectors mounted to the frame;
a control system mounted with respect to the frame;
a first photosensor operatively connected to the control system and configured to transmit a first signal to the control system that is indicative of the amount of light reaching the first photosensor;
a second photosensor operatively connected to the control system and configured to transmit a second signal to the control system that is indicative of the amount of light reaching the second photosensor;
an alarm system operatively connected to the control system and configured to selectively produce an alert signal;
wherein the control system is configured to cause the alarm system to produce the alert signal when the first signal indicates that the amount of light reaching the first photosensor is less than a predetermined amount and the second signal indicates that the amount of light reaching the second photosensor is above a predetermined amount.

2. The poaching detection apparatus of claim 1, wherein the alarm system includes at least one speaker configured to selectively produce an audible sound; and
wherein the alert signal is the audible sound.

3. The poaching detection apparatus of claim 1, wherein the alarm system includes a light-producing device configured to selectively emit light in the visible spectrum; and
wherein the alert signal is the light in the visible spectrum.

4. The poaching detection apparatus of claim 1, wherein the alarm system includes a wireless signal transmitter configured to transmit a wireless signal to a wireless communications network; and
wherein the alert signal is the wireless signal.

5. The poaching detection apparatus of claim 4, wherein the wireless communications network is configured to cause a portable electronic device to produce a second alert signal in response to the wireless signal.
